(19) United States
(12) Patent Application Publication
(10) Pub. No.: US 2005/0237338 A1
(43) Pub. Date: Oct. 27, 2005

(54) Embedded holograms on optical cards

(75) Inventor: Kevin Wilson, Denver, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: BSI2000, Inc., Lakewood, CO (US)

(21) Appl. No.: 10/832,930

(22) Filed: Apr. 26, 2004

(51) Int. Cl. G09G 5/02

(52) U.S. Cl. 345/589

(57) ABSTRACT

A bit sequence is generated that produces a visible image on an optical card when written to the optical card as a series of etched and unetched states according to an optical-card writing protocol. For pixels distributed in two dimensions, an average intensity of the image in each pixel is determined. A bit arrangement is assigned to the pixel in accordance with the determined average intensity. For tracks distributed in one of the two dimensions across multiple of the pixels, bits defined by the pixel bit arrangements are mapped and distributed linearly within the track to a two-dimensional representation.

### BACKGROUND OF THE INVENTION

This application relates generally to optical cards. More specifically, this application relates to methods and systems for writing images visible to the naked human eye on optical cards.

The development of optical cards has been relatively recent. They are cards that are typically made to be about the size of a standard credit card and which store digitized information in an optical storage area. The information written to the optical storage area is generally written according to a standards protocol that is intended, among other things, to mitigate the possibility of certain types of errors that may result from the physical layout of information in the storage area. Because they are standardized, such protocols are generally incorporated into optical drives that are used to write information to optical cards.

The information encoded in the optical storage area often includes information that identifies a holder of the card, and as such optical cards are expected to become widely used as identification instruments. Indeed, a number of government authorities have already begun to issue optical cards for use as national identity cards, as immigration cards, and the like. There is always a concern that identification instruments may be forged so that efforts are continuously being made to enhance security features of such instruments to render them more difficult to forge. In the case of optical cards, one security feature that has been used is to write optical data within the optical storage area in a manner intended to produce an image over a portion of the optical storage area that is visible to the naked human eye. Such data are written solely for the purpose of forming a visible image, rather than being used to encode information in the way that other portions of the optical storage area are used. Such images are sometimes referred to in the art as “embedded holograms,” although they do not use optical interference patterns to form three-dimensional images.

Current efforts to produce embedded holograms in optical cards have relied on circumventing the standardized writing protocols. This is done by using special microcode that bypasses the standard encoding protocol to write a bitmap to the optical storage area. But circumventing standards in this way makes it impossible to use off-the-shelf optical drives that are designed to implement the protocols, thereby increasing the expense associated with such a security feature.

There is accordingly a general need in the art for methods and systems of writing visible images to optical cards that can accommodate standardized writing protocols.

### BRIEF SUMMARY OF THE INVENTION

Embodiments of the invention thus provide methods and systems for generating a bit sequence that produces a visible image on an optical card when written to the optical card as a series of etched and unetched states according to an optical-card writing protocol. The image might comprise, for instance, a picture of an authorized cardholder of the optical card. For each of a plurality of pixels distributed in two dimensions, an average intensity of the image in the pixel is determined. A bit arrangement is assigned to the pixel in accordance with the determined average intensity. For each of a plurality of tracks distributed in one of the two dimensions across multiple of the pixels, bits defined by the pixel bit arrangements are mapped and distributed linearly within the track to a two-dimensional representation.

In one embodiment, each pixel covers multiple tracks, and the bit arrangement comprises a byte assigned to each track within the pixel. For instance, each pixel may cover three tracks. The byte may also sometimes comprise a plurality of bytes.

The optical-card writing protocol may comprise writing the series of etched and unetched states according to a modified-frequency-modulation return-to-zero (“MFM-RZ”) modulation scheme. In such instances, the bit arrangement for each byte may comprise a byte assigned to each pixel. For example, at least one of the bytes may be 0xFF or 0x00 and another of the bytes may be 0x55 or 0xAA. In one embodiment, the bit arrangement for at least one of the pixels comprises a sequence of bytes of 0x92-0x49-0x24 or 0x6D -0xB6-0xDB. The bit arrangement may be one of a plurality of distinct predetermined bit 30 arrangements, with each of the distinct predetermined bit arrangements corresponding to a predetermined range of average intensity.

In some instances, the two-dimensional representation may be transposed, and the transposition may be reversed for writing the bits to the optical card.

These methods may be embodied in a computer-readable storage medium having a computer-readable program embodied therein for directing operation of a computational device that includes a processor. The computer-readable program includes instructions for operating the computational device to generate the bit sequence as described above.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIGS. 1A-1C provide schematic illustrations of different forms of optical cards that may be used in embodiments of the invention;,

FIG. 2 provides an illustration of an interleaved data sector within an optical storage area on an optical card for one embodiment;

FIG. 3 provides an illustration of a modified-frequency-modulation return-zero formatting protocol;

FIG. 4 is a flow diagram illustrating methods for preparing an embedded hologram matrix in one embodiment;

FIG. 5 provides a schematic illustration of data organization for writing an embedded hologram to an optical card in one embodiment;

FIG. 6 is a schematic illustration of a computer system on which methods of the invention may be embodied; and

FIG. 7 is a flow diagram illustrating methods for writing an embedded hologram to an optical card using the prepared embedded hologram matrix.

### DETAILED DESCRIPTION OF THE INVENTION

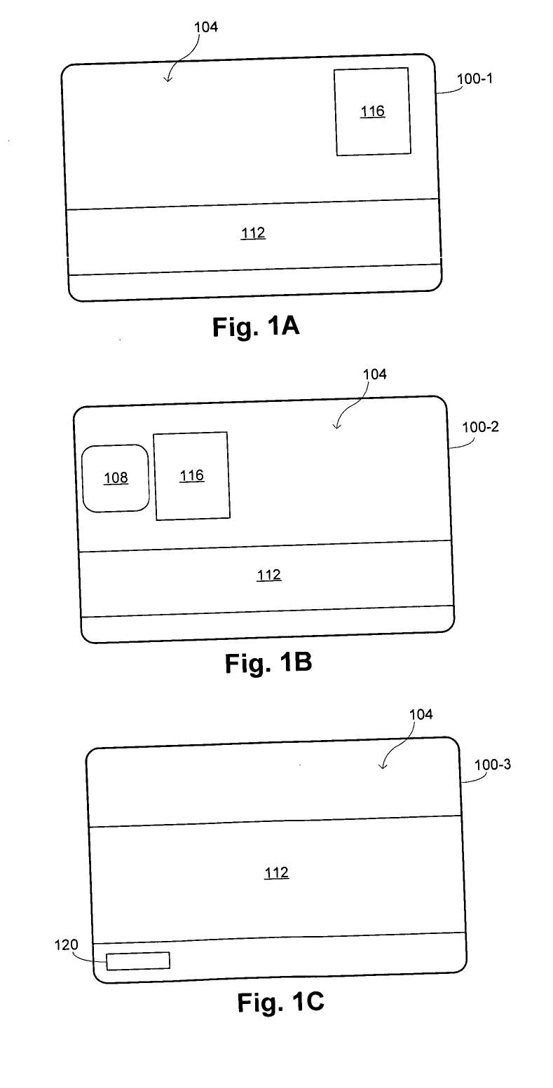

Embodiments of the invention provide methods and systems that permit bitmaps to be written to optical cards to form an image visible to the human eye, thereby permitting the production of embedded holograms on such cards. Such embodiments may function well with a variety of optical-card designs, some of which are illustrated in FIGS. 1A-1C. Such optical cards may be of the specific type described in U.S. Pat. No. 5,979,772, entitled “OPTICAL CARD” by Jiro Takei et al., the entire disclosure of which is incorporated herein by reference for all purposes, but more generally include any card that uses optical storage techniques. Such optical cards are typically capable of storing very large amounts of data in comparison with magnetic-stripe or smart cards. For example, a typical optical card may compactly store up to 4 Mbyte of data, equivalent to about 1500 pages of typewritten information. As such, optical cards hold on the order of 1000 times the amount of information as a typical smart card. Unlike smart cards, optical cards are also impervious to electromagnetic fields, including static electricity, and they are not damaged by normal bending and flexing.

Many optical cards use a technology similar to the one used for compact discs (“CDs”) or for CD ROMs. For example, a panel of gold-colored laser-sensitive material may be laminated on the card and used to store the information. The material comprises several layers that react when a laser light is directed at them. The laser etches a small hole, about 2 μm in diameter, in the material; the hole can be sensed by a low-power laser during a read cycle. The presence or absence of the etch spot defines a binary state that is used to encode data. In some embodiments, the data can be encoded in a linear x-y format described in detail in the ISO/IEC 11693 and 11694 standards, the entire contents of which are incorporated herein by reference for all purposes.

FIG. 1A provides a diagram that illustrates a structure for an optical card in one embodiment. The card 100-1 includes a cardholder photograph 116, an optical storage area 112, and a printed area 104 on one side of the card. The other side of the card could include other features, such as a bar code(s) or other optically recognizable code, a signature block, a magnetic stripe, counterfeiting safeguards, and the like. The printed area 104 could include any type of information, such as information identifying the cardholder so that, in combination with the photograph 116, it acts as a useful aid in authenticating a cardholder's identity. The printed area 104 could also include information identifying the issuer of the card, and the like. The optical storage area 112 holds digitized information, and may comprise a plurality of individual sections that may be designated individually by an addressing system.

Another embodiment of an optical banking card 100-2 is illustrated in FIG. 1B. This embodiment adds electronics 108 to the optical card 100-2 to provide smart-card capabilities. The electronics 108 may be interfaced with contacts on the surface of the card 100-2. The electronics could include a microprocessor, nonvolatile memory, volatile memory, a cryptographic processor, a random-number generator, and/or any other electronic circuits. Unlike the optical storage area 112, information stored in the electronics 108 is not discernible without destroying the card 100-2. Electronic security measures could be used to protect reading information stored in the electronics 108.

A further embodiment of an optical banking card 100-3 is shown in FIG. 1C. To illustrate that different embodiments may accommodate different sizes of optical storage areas, this embodiment uses a larger optical storage area 112 than the embodiments of FIGS. 1A or 1B. In addition, a radio-frequency identification (“RFID”) tag 120 that can be read by proximity readers may be included.

The fact that the information in the optical storage area of optical cards is generally visible is exploited in embodiments of the invention to produce the embedded holograms. Such embedded holograms are produced by writing a bit pattern to the optical storage area so that contrasts provided by adjacent bits provide a visible grayscale image. The grayscale image may be formed only from two different types of bit patterns that correspond to colors “black” and “white.” In other embodiments, one or more bit patterns that correspond to intermediate “gray” colors may additionally be included in forming the image. It should be understood that as used herein, references to “colors,” such as “black,” “white,” and “gray,” are intended to refer to different intensities of darkness that are perceived by the human eye as a result of the different bit patterns; no reference to any additive or subtractive theory of color is intended by such references. Several examples are provided below of specific bit patterns used in specific embodiments to generate “black,” “white,” and intermediate “gray” “colors.” Examples of images that may be produced include grayscale reproductions of images that appear elsewhere on the card, such as of the photograph 116 of the cardholder, although the invention is not limited by any particular image. Embedding an image that appears elsewhere on the card within the optical storage area itself enhances the security of the card by, for example, making it especially difficult for a forger to modify an existing card to substitute a different photograph.

Embodiments of the invention accommodate a protocol for writing information to optical cards by generating a bit sequence that results in a desired grouping of bit patterns to produce an image when that bit sequence is written to the optical storage area using the protocol. For purposes of illustration, the following description provides examples that use a protocol drawn from Annex B of the ISO/IEC 11694-4 Specification, the entire disclosure of which is incorporated herein by reference. But there are, of course, a variety of different writing protocols that may be used and the invention is not intended to be limited to any specific writing protocol; the principles described herein may be used with many different writing protocols in different embodiments, as will be evident to those of skill in the art after reading this disclosure.

Annex B of the ISO/IEC 11694-4 Specification describes a writing protocol for optical cards that uses a pulse-position modulation recording method with modified-frequency-modulation return-to-zero (“MFM-RZ”), among other modulation codes. The MFM-RZ modulation is sometimes also referred to in the art as a (1, 3) run-length-limited (“RLL”) modulation. The ISO/IEC 11694-4 Specification describes a logical data structure on optical cards that has a number of different tracks, each of which may comprise certain types of specified information and which are laid out in a defined manner. The number of tracks may depend on both the data capacity of the cards, as dictated by the size of the optical storage area, and on the density of tracks within the optical storage area. Of these, type-5 formatting is suitable for the storage of data and provides a convenient format to be used for generating the embedded holograms; in other embodiments, other formats suitable for the storage of header information and the like may alternatively be used.

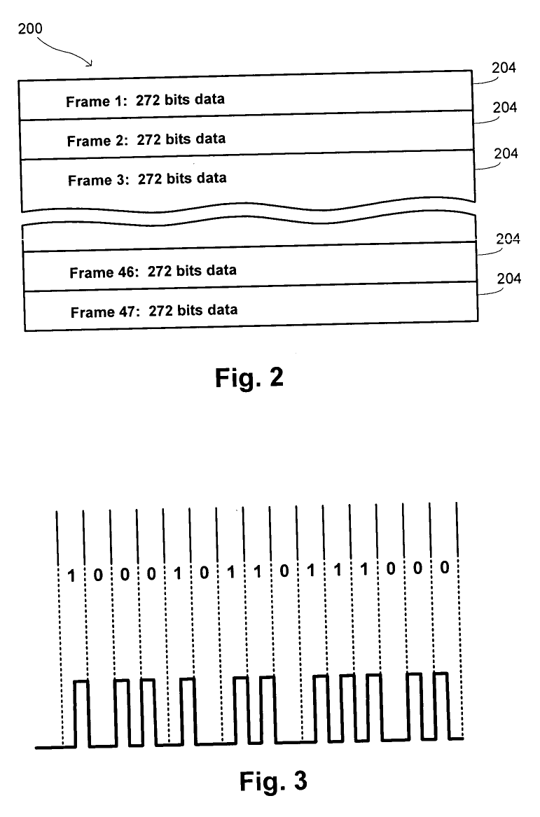

One security feature that is common to the different formats, including the track-5 format, is “interleaving,” in which the physical location of information is distributed in a manner that generally renders data more immune to clustered-bit errors. The implementation of such interleaving for type-5 formatting is illustrated schematically in FIG. 2 for a data track 200 having a byte length of 1598. This particular byte length is defined by the protocol, which specifies generally that data be arranged in rectangular matrix arrays of 272 bits with f rows 204, where f is the interleaving factor. These rectangular matrix arrays are sometimes referred to as “interleaving frames” because of the way in which their use causes the interleaving of data. In the case of type-5 formatting, the interleaving factor f=47 so that the total bit length of the interleaving frame is 12,784. When writing to the optical card, the interleaving frame is filled in by row and written to the optical card, column by column from the same end for each row.

FIG. 3 provides an illustration of how bit information may be written to the card for exemplary bit string using MFM-RZ encoding. Such an encoding scheme is a modification of a simple frequency modulation in which a flux reversal is used to indicate a “1” bit and the lack of a flux reversal is used to indicate a “0” bit. In writing to an optical card, flux reversals are indicated by the use of etched (“E”) and unetched (“B”) states. With an MFM-RZ encoding scheme, each “1” bit is encoded as BE, and each “0” bit may be encoded as BB if it follows a “1” bit or as EB if it follows a “0” bit. In the example of FIG. 3, the unetched states B are thus indicated for the illustrative string as unelevated while the etched states E are indicated as elevated.

It will thus be appreciated that with an MFM-RZ encoding scheme, a series of 1 bits corresponds to a series BEBEBE . . . while a series of alternating bit 01010101 or 10101010 includes a series . . . EEBBEEBBEEBB. . . . To the human, these series contrast with each other to create the perception of two-color states that may be used to build up an image on the optical storage area. The inventor has found that within an MFM-RZ encoding scheme, a good “black” value may be provided by the bytes 0xFF and 0x00, where the “0x” notation is used to indicate that the bytes are expressed in hexadecimal notation. Similarly, a good “white” value may be provided by the bytes 0x55 and 0xAA. Certain intermediate values also provide some contrast to these and may be used is providing “gray” states, in particular repeating sequences of 0x92-0x49-0x24 or of 0x6D -0xB6-0xDB. In other instances, gray values of individual pixels may be provided by assigned black and white values (or even combinations of gray-value sequences) to portions of the pixels defined by individual tracks on the optical storage area. Such embodiments are described further below, and may be used to provide a wide variety of contrast in generating embedded images.

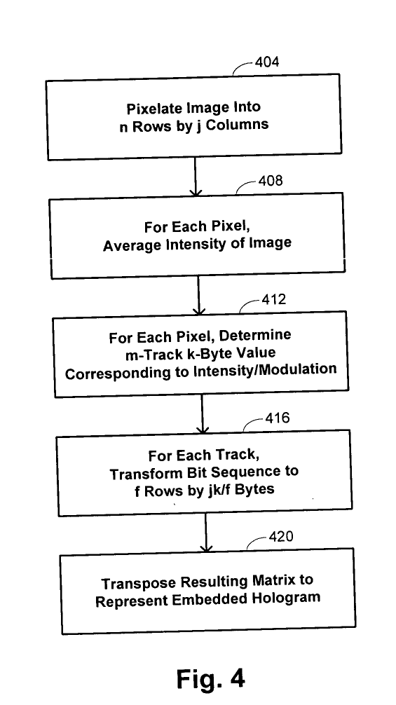

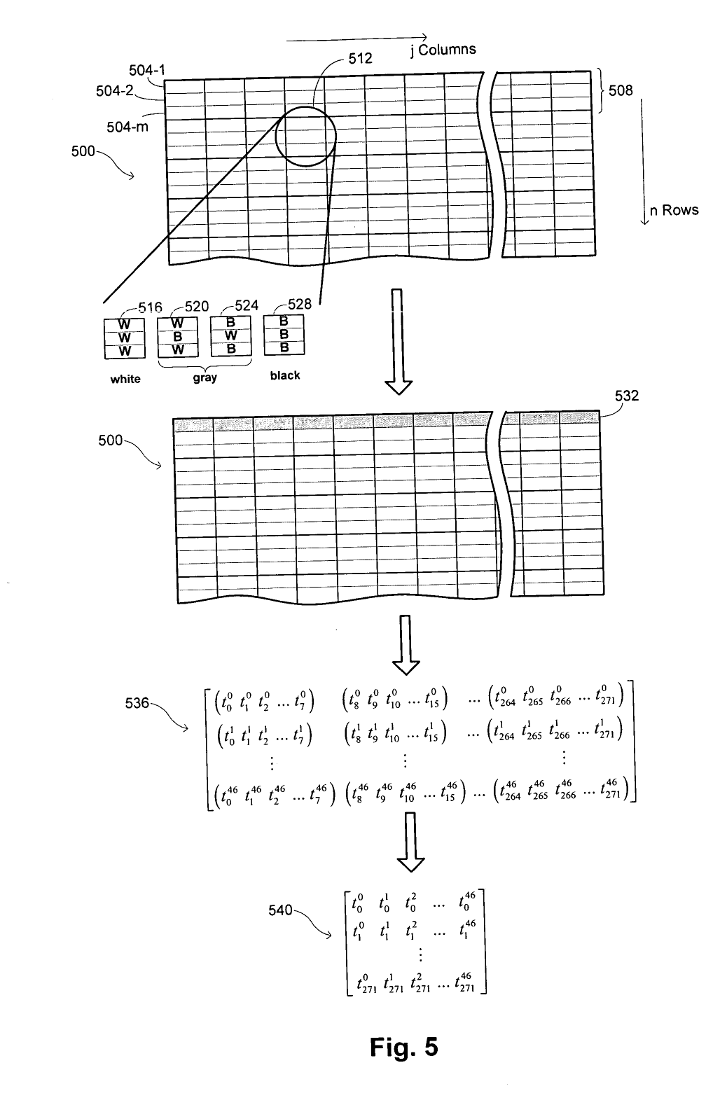

FIG. 4 provides a flow diagram that illustrates methods for generating a bit sequence suitable for writing an embedded-hologram image to the optical storage area of an optical card. In the following description of FIGS. 4, reference is sometimes also made to FIG. 5, which provides a schematic illustration of how bits are organized during application of such methods. The method may begin by pixelating the image to be embedded (say, an image of the authorized cardholder) at block 404 of FIG. 4 into a structure having n rows and j columns. The number of rows and columns in the pixelization may be limited by the size of the optical storage area and by the writing protocol; for example, in the case above where type-5 formatting is to be used, the number of columns j may be limited to being less than 1598. This is illustrated at thc top of FIG. 5, for example, where a template 500 overlaid on an image includes j columns and n rows 508 defining nj pixels 512.

At block 408, the intensity of each pixel is averaged so that a determination may be made at block 412 of a byte value that corresponds to the intensity, according to the modulation scheme that is to be used. Block 412 contemplates a number of different embodiments that may be used, including instances where each pixel corresponds to portions of one or more tracks in the optical storage area and including instances where the number of bytes used for each track within the pixel is one or more. The number of tracks is denoted by m and may be used to enhance the resolution of intermediate gray colors; the number of bytes is denoted by k and may be used in resizing a width of the image by a scale factor 1/k. The determination of byte values may be illustrated in a simple embodiment in which m=k=1, i.e. where each pixel is defined by a single byte value, and in which the byte values are limited to “white” and “black” values, say to 0x55 and 0xFF for an embodiment that uses MFM-RZ encoding as described above. In such an instance, a threshold intensity value Iₜₕ may define whether the white or black value is assigned to the pixel depending only on whether the average intensity determined at block 408 is greater or less than Iₜₕ. It is noted that such a determination may be made even if the original image is a traditional color image having hues of red, blue, and green.

A further illustration is one in which m is greater than one, such as shown in FIG. 5 for a case where m=3. In such an embodiment, each pixel 512 may include portions of three tracks 504 that correspond to subrows of one of the n rows 508. In such an embodiment, when k=1, a different byte value may be assigned to each of the m tracks within a given pixel to provide intermediate grayscale levels. For instance, with m=3, blocks 516, 520, 524, and 528 of FIG. 5 illustrate different grayscale levels that may be provided, increasing in darkness from “white” to “black.” A first pixel 516 is rendered “white” by having each of the three tracks assigned to a white-value byte 0x55; a second pixel 520 is rendered a “light gray” by having the outer tracks assigned to a white-value byte 0x55 and the inner track assigned to a black-value byte 0xFF; a third pixel 524 is rendered a “dark gray” by having the outer tracks assigned to a black-value byte 0xFF and the inner track assigned to a white-value byte 0x55; and a fourth pixel 528 is rendered “black” by having each of the three tracks assigned to a black-value byte 0xFF. To determine which of the four assignments to use, intensity values may be binned into four groups with assignment for each pixel being determined by the group into which it is binned.

A further illustration is one in which k is also greater than one. As indicated above, the assignment of k bytes to each pixel (or to each track within each pixel for cases where m>1) acts to scale the image in width by a factor 1/k. This is because the use of a greater number of bytes that are to be written according to the writing protocol reduces the number of columns that may be used in the image to int[j/k]. For instance, in an embodiment where k=4, the 1598 bytes accommodated for the type-5 formatting described above may be used only for 399 columns in the image pixelization. In addition, the availability of multiple bytes spread horizontally within a given pixel allows a finer grayscale to be defined in the horizontal direction of the pixels in addition to the finer scale made available for the vertical direction by the use of m>1. In an exemplary embodiment in which m=3 and k=4, a grayscale table may be defined as follows (using standard C notation), for a black-value byte 0xFF and a white-value byte 0x55:

static const DWORD graytable [13] [3] =
{
/* 0*/ 0x55555555, 0x55555555, 0x55555555,
/* 1*/ 0x55555555, 0x55FF5555, 0x55555555,
/* 2*/ 0xFF555555, 0x55555555, 0x5555FF55,
/* 3*/ 0xFF555555, 0x55FF5555, 0x5555FF55,
/* 4*/ 0xFF55FF55, 0x55555555, 0xFF55FF55,
/* 5*/ 0xFF55FF55, 0x55FF5555, 0xFF55FF55,
/* 6*/ 0xFF55FF55, 0xFF55FF55, 0xFF55FF55,
/*˜5*/ 0x55FF55FF, 0xFF55FFFF, 0x55FF55FF,
/*˜4*/ 0x55FF55FF, 0xFFFFFFFF, 0x55FF55FF,
/*˜3*/ 0x55FFFFFF, 0xFF55FFFF, 0xFFFF55FF,
/*˜2*/ 0x55FFFFFF, 0xFFFFFFFF, 0xFFFF55FF,
/*˜1*/ 0xFFFFFFFF, 0xFF55FFFF, 0xFFFFFFFF,
/*˜0*/ 0xFFFFFFFF, 0xFFFFFFFF, 0xFFFFFFFF
};

In this table, the complementary nature of various scale values has been noted explicitly by identifying certain of the resulting thirteen scale values with a tilde when they are complements of other scale values. The table has been organized with a purely white pixel at the top (scale value 0) and a purely black pixel at the bottom (scale value ˜0), with intermediate grayscale values identified between them. To determine which of the possible grayscale assignments to use, intensity values for each pixel may be binned into thirteen groups with assignment for that pixel being determined by the group into which it is binned.

In many embodiments where only a single white-value byte and a single black-value byte are used, the number of grayscale values may be equal to mk+1. Thus, in the example provided above, with m=k=1, there are two possible states for each pixel; for the example with m=3 and k=1, there are four possible states for each pixel; and for the example with m=3 and k=4, there are thirteen possible states for each pixel. The number of states may be increased further in those embodiments that provide for other byte configurations that purely black or purely white values, such as the repeating sequences of 0x92-0x49-0x24 or of 0x6D -0xB6-0xDB.

Once the byte values have been assigned for each pixel, the bit sequences may be transformed for each track according to the writing protocol at block 416. This transformation may result in interleaving as discussed above, potentially causing bytes that are closely related to portions of the image to become widely separated. Separation of such bytes may also occur when m>1 because the transformation is generally performed on a single-track level. For instance, in the embodiment illustrated in FIG. 5, a single track 532 (shown to be shaded in FIG. 5) of a three-track row 508 of the template 500 is transformed at block 416. To effect the interleaving with an interleaving factor f, the kj bytes of the selected track 532 are arranged in a matrix having f rows and jk/f bytes in each row. This may be illustrated for a particular example using the type-5 formatting described above for data tracks in the optical storage area having byte lengths of 1598 and using an interleaving factor f=47. Since the total byte length is equal to the product jk, it is unnecessary to be concerned at this stage of the process whether there is any width scale factor being applied since the transformation of the bytes will proceed in the same fashion for any value of k. With an interleaving factor f=47, the 1598 bytes are arranged into 34-byte (272-bit) stings. Thus, denoting each bit by

$${t}_{column}^{row} ,$$

where the superscript identifies the row number and the subscript identifies the column number in the interleaving frame, the selected track 532 is mapped into the following matrix 536:

$$[ \begin{matrix}( {t}_{0 }^{0} {t}_{1}^{0} {t}_{2}^{0} … {t}_{7}^{0} ) & ( {t}_{8}^{0} {t}_{9}^{0} {t}_{10}^{0} … {t}_{15}^{0} ) & … & ( {t}_{264}^{0} {t}_{265}^{0} {t}_{266}^{0} … {t}_{271}^{0} ) \\ ( {t}_{0}^{1} {t}_{1}^{1} {t}_{2}^{1} … {t}_{7}^{1} ) & ( {t}_{8}^{1} {t}_{9}^{1} {t}_{10}^{1} … {t}_{15}^{1} ) & … & ( {t}_{264}^{1} {t}_{265}^{1} {t}_{266}^{1} … {t}_{271}^{1} ) \\ ⋮ & ⋮ & & ⋮ \\ ( {t}_{0}^{46} {t}_{1}^{46} {t}_{2}^{46} … {t}_{7}^{46} ) & ( {t}_{8}^{46} {t}_{9}^{46} {t}_{10}^{46} … {t}_{15}^{46} ) & … & ( {t}_{264}^{46} {t}_{265}^{46} {t}_{266}^{46} … {t}_{271}^{46} )\end{matrix} ] .$$

In this matrix, the individual bits are shown, but have been grouped for purposes of illustration according to the assigned bytes. Because of the way in which individual bits are written onto the optical storage area according to the protocol, this matrix may be transposed at block 420 to produce a set of matrices 540 that represent the embedded hologram:

$$[ \begin{matrix}{t}_{0}^{0} & {t}_{0}^{1} & {t}_{0}^{2} & … & {t}_{0}^{46} \\ {t}_{1}^{0} & {t}_{1}^{1} & {t}_{1}^{2} & … & {t}_{1}^{46} \\ & & ⋮ & & \\ {t}_{271}^{0} & {t}_{271}^{1} & {t}_{271}^{2} & … & {t}_{271}^{46}\end{matrix} ] .$$

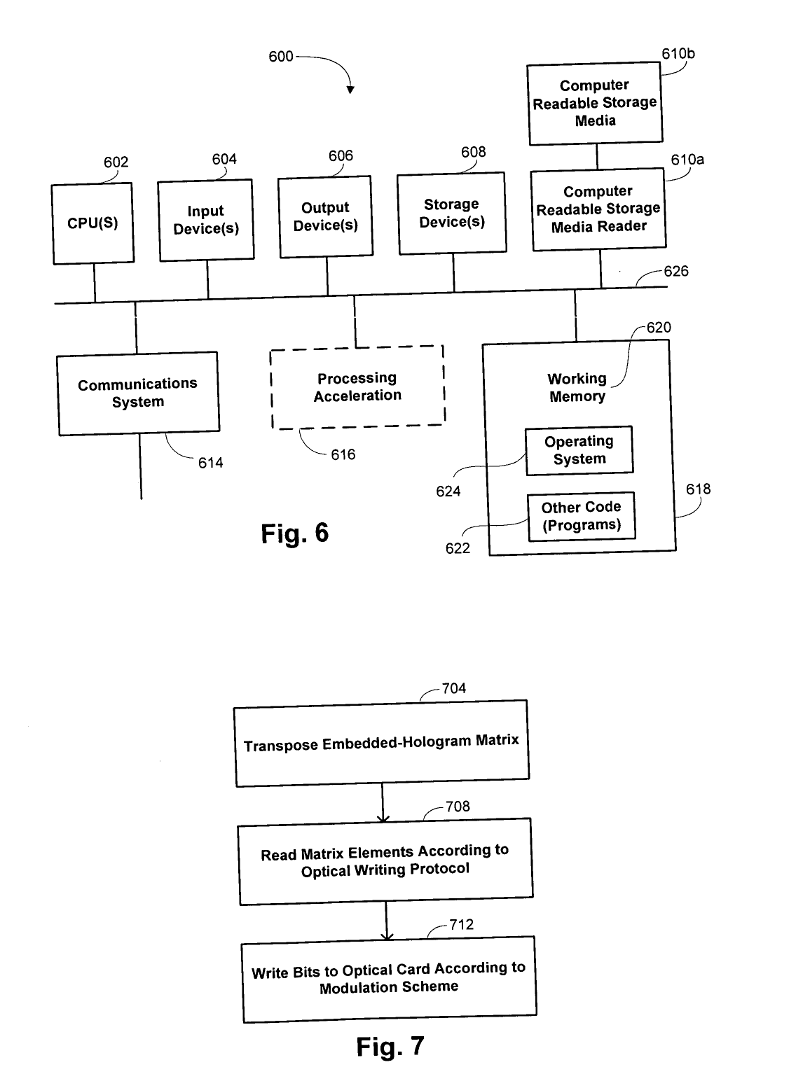

This process may be performed using any suitable computation method implemented on any suitable computational device. For example, FIG. 6 provides a schematic illustration of one suitable computational device 600. FIG. 6 broadly illustrates how individual system elements may be implemented in a separated or more integrated manner. The computational device 600 is shown comprised of hardware elements that are electrically coupled via bus 626, including a processor 602, an input device 604, an output device 606, a storage device 608, a computer-readable storage media reader 610a, a communications system 614, a processing acceleration unit 616 such as a DSP or special-purpose processor, and a memory 618. The computer-readable storage media reader 610a is further connected to a computer-readable storage medium 610 b, the combination comprehensively representing remote, local, fixed, and/or removable storage devices plus storage media for temporarily and/or more permanently containing computer-readable information. The communications system 614 may comprise a wired, wireless, modem, and/or other type of interfacing connection. In some embodiments, the computational device may be an optical drive that additionally includes an optical-card writer for writing the determined bit sequences to an optical card.

The computational device 600 also comprises software elements, shown as being currently located within working memory 620, including an operating system 624 and other code 622, such as a program designed to implement methods of the invention. For example, the intensities determined at block 412 of FIG. 4 may be stored as a C-type array of the form: unsigned byte [tracks] [bytes], where tracks is the number of tracks nm and bytes is the number of bytes jk in each track in the template 500. Such a C-type array may be considered to define a matrix stored in the C language in row-major order, i.e., in which the column array values change most rapidly:
A [0] [0] , A [0] [1], A [0] [2], . . . , A [0] [jk-1], A [1] [0], A [1][1], . . . , A [1] [jk-1], . . , A [nm-1] [0] , A [nm-1] [1], . . , A [nm-1] [jk-1],
   where row coordinate of the array is defined first, followed by the column element. Each row of the C-type array, i.e., A [i] [0], A[i] [1], . . . , A [i] [jk-1], may be mapped by the software to an interleaving frame matrix, also represented as an array: unsigned char y [47] [34], having bits t defined by the mapping A [i] [0 . . . jk-1]→t [0, 0 . . . 271], t [1, 0 . . . 271], . . . t [46, 0 . . . 271]. The bitwise transformation of this array thus produces a new matrix array unsigned byte x[34] [47]. The embedded hologram is thus represented by a set of the x arrays, the number of such arrays being nm.

FIG. 7 provides a flow diagram illustrating how the set of x arrays may be used in writing the embedded hologram to the optical storage area. As indicated at block 704, the reverse of the previously described transform is performed on the data before calling a write procedure. In particular, each track of the optical storage area to which data are to be written is viewed as defined by an array of unsigned byte x [34] [47],which is transformed bitwise into an array y [47] [34] . This array is then read at block 708 according to the optical writing protocol and written to the optical storage area of the optical at block 712 using the modulation scheme defined by that protocol. The resulting bit pattern etched into the optical card is thus a grayscale image that generally corresponds to the original image in a fashion that allows it to be seen with the naked human eye.

Thus, having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

1. A method for generating a bit sequence that produces a visible image on an optical card when written to the optical card as a series of etched and unetched states according to an optical-card writing protocol, the method comprising:
for each of a plurality of pixels distributed in two dimensions,
determining an average intensity of the image in the pixel; and
assigning a bit arrangement to the pixel in accordance with the determined average intensity; and
for each of a plurality of tracks distributed in one of the two dimensions across multiple of the pixels, mapping bits defined by the pixel bit arrangements and distributed linearly within the track to a two-dimensional representation.

2. The method recited in claim 1 wherein:
each pixel covers multiple tracks; and
the bit arrangement comprises a byte assigned to each track within such each pixel.

3. The method recited in claim 2 wherein the byte comprises a plurality of bytes.

4. The method recited in claim 2 wherein each pixel covers three tracks.

5. The method recited in claim 1 wherein the optical-card writing protocol comprises writing the series of etched and unetched states according to a modified-frequency-modulation return-to-zero (“MFM-RZ”) modulation scheme.

6. The method recited in claim 5 wherein the bit arrangement for each pixel comprises a byte assigned to the each pixel.

7. The method recited in claim 6 wherein at least one of the bytes is selected from the group consisting of 0xFF and 0x00.

8. The method recited in claim 6 wherein at least one of the bytes is selected from the group consisting of 0x55 and 0xAA.

9. The method recited in claim 5 wherein the bit arrangement for at least one of the pixels comprises a sequence of bytes selected from the group consisting of 0x92-0x49-0x24 and 0x6D-0xB6-0xDB.

10. The method recited in claim 1 wherein each bit arrangement is one of a plurality of distinct predetermined bit arrangements, each of the distinct predetermined bit arrangements corresponding to a predetermined range of average intensity.

11. The method recited in claim 1 further comprising transposing the two-dimensional representation.

12. The method recited in claim 11 further comprising reversing the transposing of the two-dimensional representation.

13. The method recited in claim 1 wherein the image comprises a picture of an authorized cardholder of the optical card.

14. A method for generating a bit sequence that produces a visible image on an optical card when written to the optical card as a series of etched and unetched states according to a protocol that uses a modified-frequency-modulation return-to-zero (“MFM-RZ”) modulation scheme, the method comprising:
for each of a plurality of pixels distributed in two dimensions,
determining an average intensity of the image in the pixel; and
assigning a byte to the pixel in accordance with the determined average intensity,
wherein the byte assigned to a first of the pixels is selected from the group consisting of 0xFF and 0x00 and the byte assigned to a second of the pixels is selected from the group consisting of 0x55 and 0xAA; and
for each of a plurality of tracks distributed in one of the two dimensions across multiple of the pixels, mapping bits defined by assigning the bytes to the pixels and distributed linearly within the track to a two-dimensional representation.

15. The method recited in claim 14 wherein:
each pixel covers three tracks; and
assigning the byte to the pixel comprises assigning a byte to each of the three tracks within such each pixel.

16. The method recited in claim 15 wherein assigning the byte to each of the three tracks comprises assigning a plurality of bytes to each of the three tracks.

17. A computer-readable storage medium having a computer-readable program embodied therein for directing operation of a computational device including a processor, wherein the computer-readable program includes instructions for operating the computational device to generate a bit sequence that produces a visible image on an optical card when written to the optical card as a series of etched and unetched states according to an optical-card writing protocol in accordance with the following:
for each of a plurality of pixels distributed in two dimensions,
determining, with the processor, an average intensity of the image in the pixel; and
assigning, with the processor, a bit arrangement to the pixel in accordance with the determined average intensity; and
for each of a plurality of tracks distributed in one of the two dimensions across multiple of the pixels, mapping, with the processor, bits defined by the pixel arrangements and distributed linearly within the track to a two-dimensional representation.

18. The computer-readable storage medium recited in claim 17 wherein:
each pixel covers multiple tracks; and
the bit arrangement comprises a byte assigned to each track within such each pixel.

19. The computer-readable storage medium recited in claim 18 wherein the byte comprises a plurality of bytes.

20. The computer-readable storage medium recited in claim 18 wherein each pixel covers three tracks.

21. The computer-readable storage medium recited in claim 17 wherein the optical-card writing protocol comprising writing the series of etched and unetched states according to a modified-frequency-modulation return-to-zero (“MFM-RZ”) modulation scheme.

22. The computer-readable storage medium recited in claim 21 wherein the bit arrangement for each pixel comprises a byte assigned to the each pixel.

23. The computer-readable storage medium recited in claim 22 wherein at least one of the bytes is selected from the group consisting of 0xFF and 0x00.

24. The computer-readable storage medium recited in claim 22 wherein at least one of the bytes is selected from the group consisting of 0x55 and 0xAA.

25. The computer-readable storage medium recited in claim 21 wherein the bit arrangement for at least one of the pixels comprises a sequence of selected from the group consisting of 0x92-0x49-0x24 and 0x6D-0xB6-0xDB.

26. The computer-readable storage medium recited in claim 17 wherein each bit arrangement is one of a plurality of distinct predetermined bit arrangements, each of the distinct predetermined bit arrangements corresponding to a predetermined range of average intensity.

27. The computer-readable storage medium recited in claim 17 wherein the computer-readable program further comprises instructions for transposing the two-dimensional representation with the processor.

28. The computer-readable storage medium recited in claim 27 wherein the computer-readable program further comprises instructions for reversing the transposing of the two-dimensional representation with the processor.

29. The computer-readable storage medium recited in claim 17 wherein the image comprises a picture of an authorized cardholder of the optical card.

30. A computer-readable storage medium having a computer-readable program embodied therein for directing operation of a computational device including a processor, wherein the computer-readable program includes instructions for operating the computational device to generate a bit sequence that produces a visible image on an optical card when written to the optical card as a series of etched and unetched states according to a protocol that uses a modified-frequency-modulation return-to-zero (“MFM-RZ”) modulation scheme in accordance with the following:
for each of a plurality of pixels distributed in two dimensions,
determining, with the processor, an average intensity of the image in the pixel; and
assigning, with the processor, a bite to the pixel in accordance with the determined average intensity,
wherein the byte assigned to a first of the pixels is selected from the group consisting of 0xFF and 0x00 and the byte assigned to a second of the pixels is selected from the group consisting of 0x55 and 0xAA; and
for each of a plurality of tracks distributed in one of the two dimensions across multiple of the pixels, mapping, with the processor bits defined by assigned the bytes to the pixels and distributed linearly within the track to a two-dimensional representation.

31. The computer-readable storage medium recited in claim 15 wherein:
each pixel covers three tracks; and
the instructions for assigning the byte to the pixel comprise instructions for assigning a byte to each of the three tracks within such each pixel.

32. The computer-readable storage medium recited in claim 31 wherein the instructions for assigning the byte to each of the three tracks comprise instructions for assigning a plurality of bytes to each of the three tracks.
